(19) United States
(12) Patent Application Publication
(10) Pub. No.: US 2021/0300136 A1
(43) Pub. Date: Sep. 30, 2021

(54) PLUG-IN COUPLING SYSTEM AND COUPLING SYSTEM

(71) Applicant: JOST-WERKE DEUTSCHLAND GMBH, Neu-lsenburg (DE)

(72) Inventors: José Manuel ALGÜERA, Aschaffenburg (DE); Stephan GITZEN, Riedstadt (DE)

(21) Appl. No.: 17/260,642

(22) PCT Filed: Jul. 19, 2019
(86) PCT No.: PCT/EP2019/069528

§ 371 Date: Jan. 15, 2021

(30) Foreign Application Priority Data
Jul. 20, 2018 (DE) 10 2018 117 584.1

(51) Int. Cl. B60D 1/64; B60D 1/01; H04W 4/80

(52) U.S. Cl. CPC B60D 1/64; H04W 4/80; B60D 1/015

(57) ABSTRACT

A plug-in coupling system for connecting a motorized vehicle and a transport unit, including a plug-in device which can be mounted on the transport unit side and has a plug, and a plug socket which can be mounted on the vehicle side and into which the plug can be inserted in an operating state. The plug and the plug socket (9) have at least one transmitter and at least one receiver of a contactless communication system having a short range.

### FIELD OF INVENTION

The invention relates to a plug-in coupling system for connecting a towing and a towed vehicle optionally comprising a plug device with a plug for the towing vehicle and a plug socket into which the plug can be inserted in an operating state, for the towed vehicle or vice versa, and a coupling system for connecting a towing and a towed vehicle comprising a coupling unit for the towing vehicle and a coupling unit for the towed vehicle, wherein the coupling unit for the towed vehicle comprises at least one first mechanical coupling device and the coupling unit for the towing vehicle comprises at least one second mechanical coupling device which interacts with the first mechanical coupling device in an operating state, and the coupling unit for the towed vehicle optionally comprises at least one plug-in device having a plug and the coupling unit for the towing vehicle comprises at least one socket that is arranged on the second mechanical coupling device and complements the plug, and into which the plug can be inserted in the operating state, or vice versa. The invention also relates to a coupling unit for the towing vehicle and a coupling unit for the towed vehicle.

### BACKGROUND OF THE INVENTION

Examples of towing vehicles are the tractors of tractor-trailers, motor vehicles of an articulated train, and swap body trucks. Accordingly, examples of towed vehicles are the trailers of tractor-trailers, trailers of an articulated train, and swap bodies.

A tractor and a trailer form a tractor-trailer, in which the coupling system has a fifth wheel arranged on the towing vehicle and a kingpin which is located on the underside of the trailer and can be brought into engagement with the fifth wheel coupling and locked. For coupling the trailer, the fifth wheel coupling plate is usually designed with an entry opening that tapers in a wedge-shaped manner in the direction of travel, the entry opening having a free installation space with at least one installation space depth, which ensures that the kingpin is retracted and extended into the fifth wheel coupling. During coupling, the trailer slides on the surface of the fifth wheel coupling plate regarding its vertical alignment. Lateral guidance is ensured by the kingpin, which is positively guided into the entry opening during coupling until it reaches its locking position. This means that no components may protrude into the entry opening. The entry opening is limited at the bottom by the length of the kingpin. Components located below the entry opening, such as reinforcement ribs, can then no longer be caught by the kingpin when the trailer is coupled and uncoupled.

Analogously to this, a motor vehicle and a trailer form an articulated train, in which the coupling system for mechanical connection has a trailer coupling or pin coupling with a jaw assigned to the motor vehicle and a drawbar with a towing eye assigned to the trailer.

The coupling system also includes a plug-in coupling system. Plug-in coupling systems are known in different designs. In particular, electrical power and compressed air are transmitted via plug-in coupling systems. In recent times, however, more comprehensive safety systems, recuperation of braking energy and (partial) automation have also led to an increasing exchange of data between the towing vehicle and the towed vehicle. In the simplest case, the plug-in coupling system is a plug and a plug socket, each of which is attached to more or less elastic lines. For safety reasons, the current-carrying end of the plug-in coupling system on the towing vehicle is usually designed as a plug socket. Depending on the technical safety concept, however, it may also be useful to reverse the principle, placing the plug socket on the towed vehicle and the plug on the towing vehicle. After the towed vehicle has been coupled to the towing vehicle, the supply lines must still be connected to one another, which is usually done manually by the driver. Before the towed vehicle is uncoupled, the plug-in coupling system must be disconnected again. If this is accidentally forgotten, the plug-in coupling system or the supply lines will tear apart.

Therefore, efforts have already been made to automate the connection and disconnection of the plug-in coupling systems and to make it safer. Such systems are usually developed using one of two basic paths:

First, there are plug-in coupling systems in which a drive is used to establish a connection between the supply lines. Such an active system is described, for example, in DE 101 55 056 A1. The known plug-in coupling system comprises a plug socket which is movably arranged in a fifth wheel coupling and which can be moved into a plug on the trailer side via the plug socket's drive. To avoid damaging the socket, these systems are preferably equipped with sensors that detect the presence of a trailer and, if necessary, retract an incorrectly extended socket before the plug-in coupling system is damaged while the trailer is being coupled or uncoupled.

As an alternative to these technically complex plug-in coupling systems with movable components, efforts are being made to connect the supply lines with the aid of an attached plug or attached plug socket that are fixed in place. Such passive systems are described in the following publications.

U.S. Pat. No. 5,060,964 discloses a fifth wheel coupling in which the contacts in the end region of the fifth wheel coupling horns are arranged in a stationary manner on both sides of the insertion opening. These work together with stationary contacts on the underside of the trailer. A relative movement between the tractor-side and trailer-side contacts is prevented by a fifth wheel coupling mounted on a rotatable base. Such a fifth wheel coupling, in which the power transmission between the tractor and the trailer is diverted at one point only via the rotatable base into the ladder frame of the towing vehicle, can hardly be installed in today's towing vehicles without considerable changes in the form of reinforcements on the towing vehicle. The overall height of the fifth wheel coupling is also increased considerably, which is not accepted by vehicle manufacturers and freight forwarders, since the loading volume is reduced when a given maximum vehicle height is reached. In addition, practice has shown that since the contacts are exposed in the end area of the fifth wheel coupling horns, they are often damaged during coupling by a kingpin that is not exactly in the entry opening, thereby rendering the entire plug-in coupling system unusable.

Another prior art is DE-OS 20 39 340 with an automatic electrical air coupling which, working together with a fully automatic fifth wheel, enables the trailer of a tractor-trailer to be coupled and uncoupled without the driver having to leave the cab. The automatic electrical air coupling is realized by a two-part coupling piece that encompasses the kingpin and has contact parts on its front side that interact with contact points in the front locking area of the fifth wheel when the trailer is coupled. The coupling piece is designed as a plug-in device that has a plug and a support element, the support element having means for pivotable attachment around the kingpin. The main disadvantage of this system lies in the high mechanical load on the coupling piece, which is additionally weakened by a large number of drilled holes running longitudinally for the passage of the cables or the compressed air lines. Another major problem is the reliable contact between the coupling piece and the fifth wheel coupling in the locking area provided with lubricating grease, since the lubricating grease contaminates the contacts and a current flow cannot always be guaranteed.

Dirty or corroded contacts are also detrimental to data transmission, and can lead to reduced or faulty data transmission or even the complete breakdown of data communication between the tractor and trailer. Since drivers using automatic systems never hold plugs or plug sockets in their hands, they are less inclined to clean them. This makes contamination an even greater problem when automatic systems are used.

One way to get around this problem is to use wireless radio systems. For example, DE 10 2012 004 440 A1 discloses a device for controlling the maneuvering process of a vehicle combination. It proposes using a WLAN system to communicate between a control unit of the tractor and a control unit of the trailer.

WO 2008/094096 A1 discloses a connection device for transmitting energy and signals from a traction vehicle to a trailer. The transmission occurs using magnetic coupling.

AU 2006100302 A4 discloses a trailer coupling in which induction coils are used in a plug-in connection as an electrical connection between a tractor and trailer.

DE 103 47 561 B3 describes a tractor-trailer whose tractor has a voltage generator for generating a periodically fluctuating carrier signal, wherein a signal modulator modulates the control data onto the carrier signal and a transmitter is arranged in the tractor's fifth wheel plate to transmit the carrier signal with modulated control data to a transmitter near the trailer's coupling pin.

U.S. Pat. No. 8,465,041 B2 shows a device for electrically connecting the electronic system of a tractor with a trailer, which device is automatically connected when the trailer's coupling part is attached to that of the tractor.

US 2013/0319563 A1 discloses a communication system for trains.

U.S. Pat. No. 5,677,667 discloses a tractor-trailer combination for which a device and a method are provided that a driver who is in the towing vehicle can use to monitor the trailer's various operating states.

### SUMMARY OF THE INVENTION

The invention's task is to enable the towing vehicle and the towed vehicle to communicate with each other without interference.

That task is solved by a plug-in coupling system for connecting a towing vehicle and a towed vehicle, which optionally equips the towing vehicle with a plug device having a plug and equips the towed vehicle with a plug socket into which the plug can be inserted in an operating state, or vice versa. The plug-in coupling system is characterized in that the plug and the plug socket have at least one transmitter and at least one receiver of a contactless communication system having a short range.

The plug-in coupling system can be both an automatically connectable and a manually connectable plug-in coupling system. Automatically connectable plug-in coupling systems are exemplified in tractor-trailers having a plug and a plug socket that are automatically plugged into each other during the tractor and trailer's coupling process. Alternatively, there are also manually connectable plug-in coupling systems in which the driver plugs a plug into a complementary socket after the mechanical coupling process of the kingpin and the fifth wheel.

The task is also achieved by a coupling system for connecting a towing vehicle and a towed vehicle that assigns one coupling unit to the towing vehicle and one to the towed vehicle, wherein the coupling unit for the towed vehicle has at least one first mechanical coupling device and the coupling unit for the towing vehicle comprises at least one second mechanical coupling device that interacts with the first mechanical coupling device in an operating state, and the towed vehicle's coupling unit optionally comprises at least one plug-in device with a plug and the towing vehicle's coupling unit comprises at least one plug socket that is arranged on the second mechanical coupling device and complements the plug, which can be inserted into it in an operating state, or vice versa. The coupling system is characterized in that the plug and the plug socket have at least one transmitter and at least one receiver of a contactless communication system having a short range.

The towing vehicle is preferably a tractor, and the towed vehicle a trailer, of a tractor-trailer. Alternatively, the towing vehicle can be a motor vehicle and the towed vehicle a trailer of an articulated train. Likewise, the towing vehicle can be a swap body truck and the towed vehicle can be a swap body. Accordingly, depending on the embodiment described, the coupling unit for the towing vehicle is referred to herein as a towing-vehicle-side, motor-vehicle-side or swap-body-truck-side coupling unit and the coupling unit for the towed vehicle is referred to as a trailer-side or swap-body-side coupling unit.

If the towing vehicle is a tractor and the towed vehicle a trailer of a tractor-trailer, then the coupling unit for the towing vehicle preferably has a fifth wheel and the coupling unit for the towed vehicle has a kingpin.

If the towing vehicle is a motor vehicle and the towed vehicle is a trailer of an articulated train, the coupling unit for the towing vehicle preferably has a trailer coupling and the coupling unit for the towed vehicle has a drawbar.

Essential advantages of the systems according to the invention, and the preferred embodiments of those systems, are sometimes described in the following based only on a tractor-trailer. The same advantages can be achieved through other preferred embodiments involving a motor vehicle with a trailer (articulated train) or a swap body system having a truck and swap body. The developments described with reference to the plug-in coupling system, particularly those relating to the plug and/or the plug socket and/or the communication system, can also be transferred to the coupling system according to the invention. The developments described with reference to the coupling system, particularly those relating to the plug and/or the plug socket and/or the communication system, can also be transferred to the plug-in coupling system according to the invention if possible.

The plug-in device is preferably mounted pivotably about the kingpin.

As described above, the plug-in device and the plug socket are jointly referred to as a plug-in coupling system. The plug-in coupling system is suitable for connecting lines between the towing vehicle and the towed vehicle. The lines can be supply lines (for energy or compressed air, for example) or data transmission lines.

To transmit energy and compressed air, the plug and/or the plug socket preferably have at least one electrical and/or one pneumatic means of connection. The plug-in coupling system thus combines the transmission of energy and compressed air with the transmission of data using the contactless communication system. This limits the effort involved in connecting the towing and towed vehicles, since only one plug connection has to be made. The electrical means of connection preferably comprises a line pin and a line bore. The pneumatic means of connection preferably comprises a pneumatic pin and a pneumatic bore. The pneumatic means of connection preferably transmits both signals, particularly clocked air pulses as a control line, as well as energy, particularly as a supply line, to fill the towed vehicle's air tanks.

The plug and the plug socket are preferably designed to be connectable along a straight plug-in axis (in other words, by moving in a straight line). This is particularly achieved by using pins and complementary drilled holes as a pneumatic means of connection that extends along the plug axis so that the pins and drilled holes are directly connected to each other when the plug enters the socket linearly. The pins and drilled holes especially include those mentioned above, as well as blind pins and blind drilled holes if applicable. This allows the plug and plug socket to be connected automatically. Together with the above-mentioned combination of the transmission of energy and compressed air and the transmission of data, this results in a reliable system for connecting a towing vehicle with a towed vehicle.

Contactless communication systems having a short range offer significant advantages when used in a plug-in coupling system. To be specific, contactless systems are less susceptible to contamination than systems with contact and can be better protected against corrosion because they do not have to have a metallic surface. In a plug-in coupling system with a plug and a plug socket, the transmitter and receiver can also be arranged so as to prevent access from the outside, especially when they are plugged in. This protects the transmitter and receiver from environmental influences (especially while the vehicles are moving), enabling the towing vehicle and the towed vehicle to communicate with each other with little to no interference.

The short range is also particularly advantageous for use in tractor-trailers and other combinations (articulated trains, swap bodies with trucks, etc.) compared to communication systems having a long range. For example: if several tractor-trailers are arranged close to one another, as is often the case in parking lots, communication systems having a long range can influence or interfere with one another. This is prevented by using a communication system having a short range. Specifically, a “short range” means a range of <1 m, preferably <0.5 m, more preferably <0.01 m, the range meaning the maximum range that can be achieved under optimal conditions. The smaller the communication system's range, the less likely the system is to malfunction. However, the range must not be too short, especially when the transmitter and receiver are not adjacent to each other but are separated by some distance. The communication system's range is therefore preferably >0.1 mm, particularly >1 mm.

One advantage of the communication system is that, due to the short range, large amounts of signals can be transmitted safely without any significant external interference.

The low susceptibility of the coupling system according to the invention is also due to the special feature that the plug and plug socket take up a predefined plug position when plugged together (operating state). The dimensioning and configuration of the plug and the plug socket make it possible to precisely align the communication system's transmitter with its receiver. In addition, the plug and the plug socket generally remain in the operating state even if the combination of tractor and trailer is shaken, without any significant change in their positions relative to one another. This also leads to a low susceptibility to failure.

The communication system is preferably equipped so that signals and/or energy can be transmitted wirelessly to a smaller extent, particularly by induction.

The communication system enables the towing vehicle to exchange signals with the towed vehicle. The communication system on the towing vehicle side is preferably connected or connectable to a control device and/or an energy supply, such as a battery.

The communication system on the towed vehicle side is preferably connected or connectable to one or more of the following components:
the chassis, particularly the braking device, wheels, (driven) axles, steering and associated sensors, particularly pressure sensors, RPM sensors, temperature sensors and maintenance sensors for wear parts of the chassis
the suspension, particularly the associated pressure sensors or position sensors
sensors, particularly load sensors, stability sensors (roll sensors, yaw sensors and pitch sensors), additional maintenance sensors for wear parts, angle sensors for determining the angle between towing and towed vehicles and visual sensors (cameras)
lighting
a control device or a distribution unit of the towed vehicle, the control device and/or the distribution unit in turn being connected or connectable to one or more of the aforementioned components

This allows the communication system to be used to transmit the following signals in particular:
Bidirectional signals between the towing vehicle's control unit and the towed vehicle's brakes, such as the wheel speeds of the towed vehicle
Information about the air pressure and/or temperature of the towed vehicle's tires to the towing vehicle's control unit
Information about pressure in the towed vehicle's air suspension bellows or their position (height) to the towing vehicle's control unit, as well as bidirectional signals for the horizontal alignment of the towed vehicle
Control signals between the towing vehicle's control unit and the towed vehicle's steering
Video signals (from cameras placed on the towed vehicle, for example) to the towing vehicle's control unit
Information about the towed vehicle's load (weights and their distribution, load temperature, load contents, etc.) to the towing vehicle's control unit
Other sensor signals, such as the relative angle between the towing and towed vehicles and from roll or yaw detection sensors attached to the towing vehicle's control unit
Control signals from the towing vehicle's control unit to the towed vehicle's lighting
Information from the towed vehicle's maintenance sensors, such as wear on the brake linings or tires, to the towing vehicle's control unit
Bidirectional control signals between the towing vehicle's control unit and the towed vehicle's electrically driven axles, which are preferably powered by batteries in the trailer and are designed to receive signals from the towing vehicle and send signals to it

In preferable developments, it is envisaged that one or more of the named components receive electrical energy for their operation from an energy supply on the part of the towed vehicle and are controlled using the communication system. For example, in normal operation, the control can be based on the towing vehicle, but in the event of an unintentional separation of the towing and towed vehicle, a type of emergency operation can be initiated using the available energy.

Notwithstanding this, the communication system can also be used to transmit electrical energy (from the towing vehicle to the towed vehicle for brakes, for example), particularly to supply the brake valves with power or to directly brake the brake discs electrically. Electrical energy can also be transferred conversely, particularly electrical energy from recuperation or from solar panels.

The fifth wheel coupling preferably comprises a fifth wheel coupling plate having an entry opening that tapers in a wedge shape in the direction of travel, the entry opening being formed from a free installation space with at least one installation space depth that ensures that the kingpin moves in and out of the fifth wheel coupling.

The communication system preferably uses one of the following technologies:
Radio Frequency Identification (RFID)
Near Field Communication (NFC)
Bluetooth Low Energy (BLE)
Optical signal transmission
Radio technology (with short range).

These technologies fulfill two essential aspects of the communication system—a short range and hand high data rates—which are desired for modern tractor-trailers and the like. If two tractor-trailers are close to each another, long-range communication systems such as WLAN can cause the tractor of one tractor-trailer to influence the trailer of the other. This is a security risk.

The risk of third parties deliberately influencing signals or extracting data can also be reduced, thereby increasing data security.

For optical signal transmission, the communication system preferably has at least one optical waveguide (to be specific, one for the towing vehicle and one for the towed vehicle) as a transmitter and receiver.

Within the scope of the invention, components (transceivers) that can fulfill both functions (sending and receiving) can also be used as transmitters and receivers.

For unidirectional communication—that is, from the towing vehicle to the towed vehicle or the other way around—only one transmitter and receiver need be envisaged. If the transmitter is part of the towing vehicle's coupling unit, only communication from the towing vehicle to the towed vehicle is possible. In that case, the towed vehicle's coupling unit has the receiver. In the opposite case, the towed vehicle's coupling unit has the transmitter and the towing vehicle's coupling unit has the receiver.

To enable bidirectional communication, both the towing and the towed vehicles' coupling units have at least one transmitter and at least one receiver, or a component that can fulfill both functions.

Instead of one transmitter, several transmitters can be used on one side (to increase the data rate or create redundancy, for example). The same applies to the receivers on the other side.

Regarding the coupling unit with the plug, the at least one transmitter or the at least one receiver is preferably arranged on and/or in at least one guide pin and/or at least one blind pin and/or a plug body of the plug, particularly in the area of or on a front surface of the plug body.

Regarding the coupling unit with the socket, the at least one transmitter or the at least one receiver is arranged on and/or in at least one pin receptacle of the plug socket, particularly a blind drilled hole and/or a socket body, particularly in the area of or on a front surface of the socket body.

The blind pin and blind drilled hole have no other function besides accommodating the transmitter and/or the receiver.

The pins are each arranged in a pin receptacle in the operating state. In this case, the pin and pin receptacle preferably have either no distance at all or only a small distance from one another. This makes pins and pin receptacles well suited for receiving the communication system's transmitter and receiver. In the operating state, there is preferably an intermediate space, particularly an annular space, between the blind pin and the pin receptacle. This means that there are fewer mechanical disturbances such as friction and wear.

In principle, the pins on the socket and the pin receptacles might also be part of the plug.

The plug body and socket body likewise have no or only a small distance from one another in the operating state, their front surfaces being aligned with one another and preferably touching one another. Due to the small or non-existent spacing, these bodies are also well suited to accommodate the transmitter and receiver.

The plug body and/or the socket body preferably accommodates the transmitter or the receiver. That accommodation is preferably provided in the area of the respective front surface and is accessible from the outside. The main advantage of this arrangement is that, in the operating state, there is no material from the respective body between the transmitter and receiver, so that the transmission performance is not impaired by the respective body.

For the coupling system, it is preferably provided that the towing vehicle is a tractor and the towed vehicle a trailer of a tractor-trailer, wherein the coupling unit for the towed vehicle has at least one kingpin as the first mechanical coupling device and the plug connector around the kingpin is pivotably mounted, and wherein the coupling unit for the towing vehicle has, as a second mechanical coupling device, at least one fifth wheel which interacts with the kingpin in an operating state.

The socket is preferably arranged in a stationary manner on the fifth wheel coupling below the entry opening.

In this context, “stationary” means the plug socket's position with no drive (in other words, with no method for contacting the plug). In the case of a tractor-trailer, arranging the socket directly on the fifth wheel below the entry opening has the advantage that the fifth wheel can be designed to be very low, since the socket with the fifth wheel swivels around the location of the fifth wheel coupling when there is a vertical angle between the tractor and the trailer. This would be impossible if the tractor had a fixed plug socket. When the plug socket is attached to the tractor beneath the fifth wheel, a safety distance between the fifth wheel and the plug socket corresponding to the pivoting angle of the fifth wheel would have to be maintained, which would lead to a raised position of the fifth wheel on the tractor. This would be at the expense of the loading volume and would be unacceptable.

The plug socket is also located in a protected area, since the entry opening above the plug socket has a greater installation depth than the length of the king pin so no collision with the king pin can occur. In the direction of the trailer, the fifth wheel coupling plate can protrude beyond the socket so that the socket will not be damaged even if the trailer is too low and hits it.

The vertical level of the plug located on the plug device is essentially determined by the position of the plug socket and, since the plug socket is arranged under the entry opening determined by the length of the king pin when the trailer is coupled, it is also below the king pin.

Since the king pin locked in the fifth wheel coupling is no longer in the entry opening, the position of the socket below the entry position means that the connector is arranged on the trailer side with respect to the kingpin and, in the locked position of the kingpin, has entered below the kingpin in the socket.

Overall, since the plug socket's location is fixed, the operating state is established whenever the trailer couples with the tractor. This is paramount for the functionality of the communication device due to its short range.

The plug-in coupling system preferably comprises at least one control device arranged on the towing vehicle and/or on the towed vehicle, which is connected to a sensor for detecting the locking state of at least one of the mechanical coupling devices (the fifth wheel, for example). This makes it possible, for example, to connect and disconnect from the driver's cab of the towing vehicle together with a remote-controlled fifth wheel. The control device exemplifies a device that is connected to the transmitter and/or the receiver of the towing vehicle and/or the towed vehicle and can send or receive data via the communication system when in the operating state.

The plug and/or the plug socket are preferably made from plastic, at least in part. A plastic construction is particularly advantageous in connection with the communication system having a short range, since plastic does not interfere with the data transmission of the communication system. This is different with metal, for example. And with electrical supply lines, plastic construction reduces the cost of electrical insulation from other electrically conductive vehicle parts. In addition, the plug-in coupling system is permanently exposed to the effects of the weather (and in winter, to road salt as well), which could considerably damage the plug-in coupling system due to corrosion. But because they are made of plastic, corrosion problems are largely excluded.

In a preferable embodiment, the plug socket is aligned with an entry opening in the direction of travel.

The invention's task is also achieved by a coupling unit for a towing vehicle with a second mechanical coupling device, particularly a fifth wheel or trailer coupling with or without a jaw, and a socket arranged on the second mechanical coupling device. The coupling unit for a towing vehicle is characterized in that the socket has at least one transmitter and/or at least one receiver of a contactless communication system having a short range.

The coupling unit for a towing vehicle is suitable for a coupling system according to the above statements. The above-described advantageous developments of the coupling system can also be implemented in the coupling unit for a towing vehicle.

The fifth wheel coupling preferably has a fifth wheel coupling plate featuring an entry opening that tapers in a wedge shape in the direction of travel, the entry opening being formed from a free installation space with at least one installation space depth.

In the case of trailer coupling, the plug is preferably placed near the trailer coupling, preferably above the coupling's jaw.

The invention's task is also achieved by a coupling unit for a towed vehicle with a first mechanical coupling device, particularly a kingpin or drawbar, and a plug-in device that has a plug and is arranged on the first mechanical coupling device. The coupling unit for a towed vehicle is characterized in that the plug has at least one transmitter and/or at least one receiver of a contactless communication system having a short range.

The coupling unit for a towed vehicle is suitable for a coupling system according to the above embodiments. The above-described advantageous developments of the coupling system can also be implemented in the coupling unit for a towed vehicle.

### BRIEF DESCRIPTION OF THE DRAWINGS

To make things easier to understand, the invention is explained with reference to the figures. To that end, the figures show the following:

FIG. 1: a tractor-trailer with a coupling system according to the invention, according to a first embodiment in a side view;

FIG. 2: the coupling system according to the invention, according to FIG. 1 in a top view;

FIG. 3: the coupling system according to the invention, according to FIG. 1 in a side view in a standby state;

FIG. 4: the coupling system according to the invention, according to FIG. 1 in a side view in an operating state;

FIG. 5: a plug socket for the coupling system according to the invention from FIG. 1 in a perspective view;

FIG. 6: a plug for the coupling system according to the invention from FIG. 1 in a perspective view;

FIG. 7: a schematic section of a plug and a plug socket according to a further embodiment of the plug-in coupling system according to the invention;

FIG. 8: a schematic section of a plug and a plug socket according to a further embodiment of the plug-in coupling system according to the invention;

FIG. 9: a schematic section of a plug and a plug socket according to a further embodiment of the plug-in coupling system according to the invention.

### DETAILED DESCRIPTION OF THE INVENTION

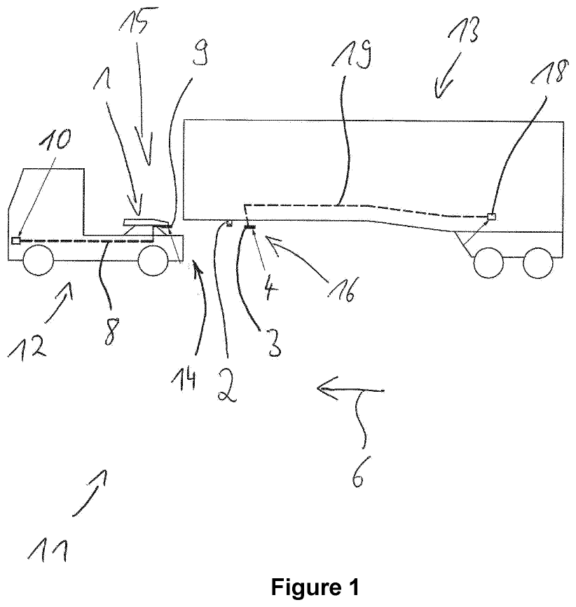

FIG. 1 shows a tractor-trailer 11 with a tractor 12 and a trailer 13. The tractor-trailer 11 has a coupling system 14 with a coupling unit 15 on the tractor side with a fifth wheel coupling 1 and a plug socket 9 and a coupling unit 16 on the trailer side with a kingpin 2 and a plug device 4 with a plug 3. Plug 3 and plug socket 9 are complementary to one another. The plug 3 can therefore be coupled to the plug socket 9. The plug device 4 and the plug socket 9 together form a plug-in coupling system 17.

The towing vehicle 12 has a control unit 10 which is connected to the socket 9 by means of a line 8. This enables data transmission between the plug socket 9 and the control unit 10. The control device 10 is additionally connected to sensors (not shown) that detect whether the operating state has been reached when the trailer 13 and the tractor 12 are coupled.

The trailer 13 has a control unit 18 that is connected to the plug 3 of the plug-in device 4 by a line 19. The line 19 enables data transmission between plug 3 and control unit 18. The control unit 18 can be connected to various elements of the trailer (such as the signaling system, brake actuators, or sensors).

In FIG. 1, the tractor 12 and the trailer 13 are in a standby state. In this state, the kingpin 2 is outside the fifth wheel 1 and is not coupled to it. Plug 3 and plug socket 9 are also not coupled to one another in the standby state.

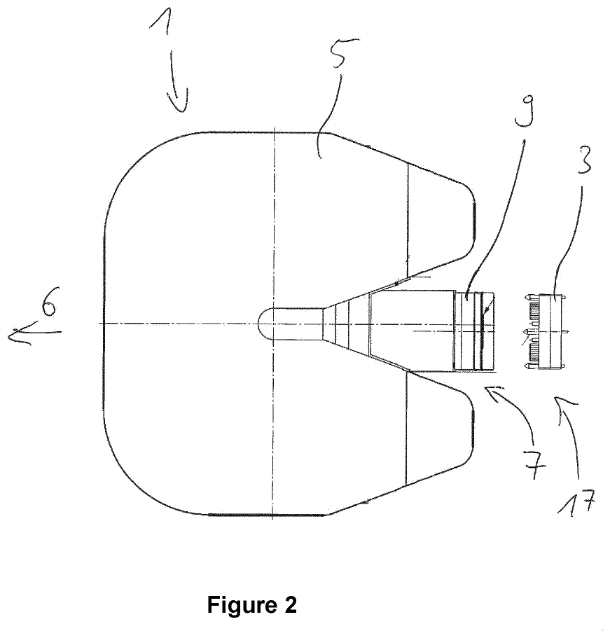

To couple the coupling units 15 and 16, the tractor 12 drives against the normal direction of travel 6 towards the trailer 13. The kingpin 2 thereby enters an entry opening 7, shown in FIG. 2, of the fifth wheel coupling plate 5 of the coupling unit 15 on the tractor.

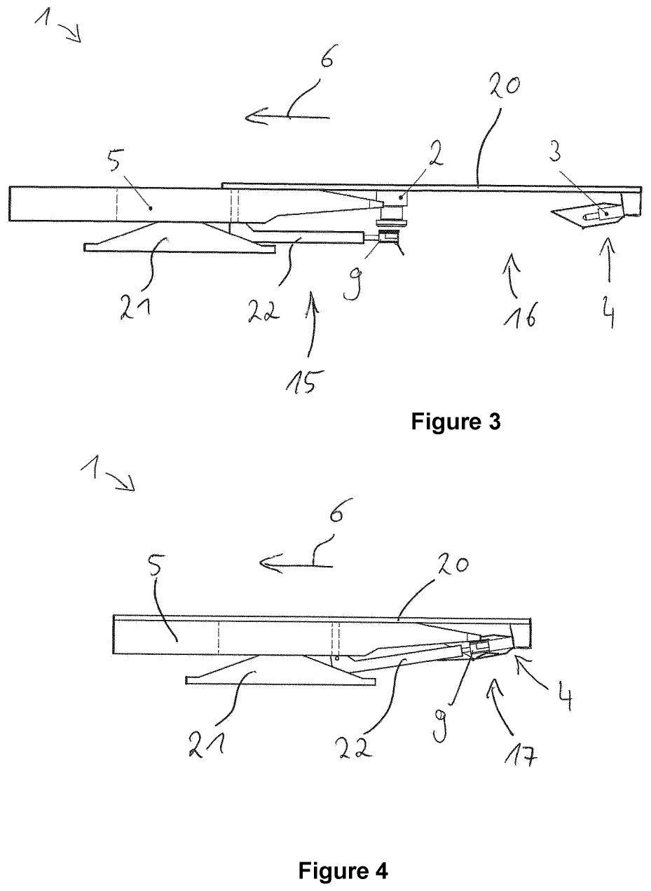

FIGS. 3 and 4 show the coupling process. In FIG. 3, the tractor 12 and trailer 13 are in a standby state similar to that shown in FIG. 1. The tractor and trailer 13 are only partially shown. The trailer has a carrier unit 20 on which the kingpin 2 and the plug-in device 4 are arranged. The kingpin 2 is already partially in the entry opening 7 but not yet coupled to the fifth wheel 1.

The fifth wheel coupling 1 has a base 21 on which a fifth wheel coupling plate 5 is arranged with the entry opening 7. The plug socket 9 is arranged on a pivotable carrier 22 that is arranged on the fifth wheel coupling plate 5 below the entry opening 7.

Plug 3 and plug socket 9 are not coupled to one another in FIG. 3. To get from the standby state into the operating state, the tractor 12 is moved counter to the direction of travel 6 as described above. In FIG. 4, the tractor 12 and trailer 13 are in the operating state. The kingpin 2 (not visible there) is coupled to the fifth wheel 1. Plug 3 and socket 9 are also coupled to one another.

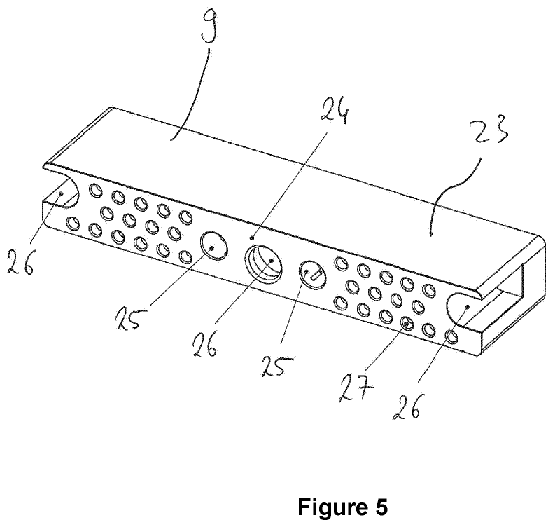

FIG. 5 shows a plug socket 9 for the coupling system 14. The plug socket 9 has an essentially cuboid socket body 23 with a front surface 24. From the front surface 24, the plug socket 9 has a plurality of pin receptacles: two pneumatic drilled holes 25, three blind drilled holes 26, and several line drilled holes 27. The pneumatic drilled holes 25 are connection elements for a pneumatic connection between the tractor 12 and the trailer 13. The blind drilled holes 26 mechanically support the coupling process. The line drilled holes 27 are each connected to a line (not shown) within the socket body 23 and each have at least one contact element (not shown) which enables electrical power and/or data to be transmitted.

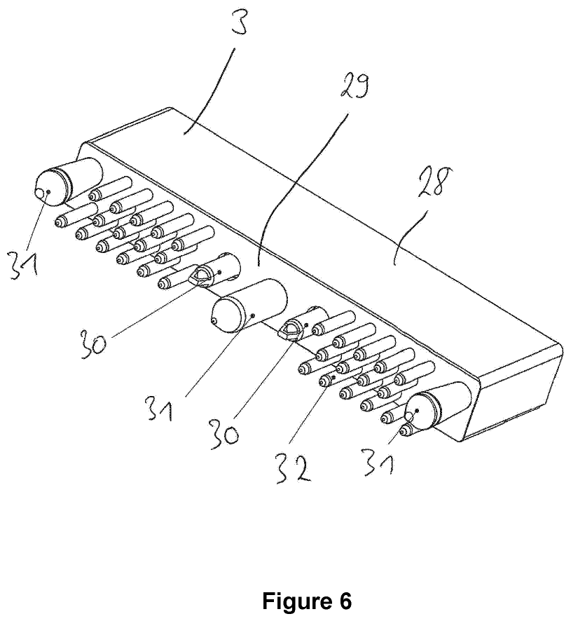

FIG. 6 shows a plug 3 for the coupling system 14. The plug 3 has an essentially cuboid plug body 28 with a front surface 29. The front surfaces 24 and 29 of the plug socket 9 and the plug 3 face each other when used as intended and lie against each other in the operating state.

The plug 3 has a plurality of pins protruding from the front surface 29: two pneumatic pins 30, three guide pins 31, and several line pins 32. In the operating state, the pneumatic pins 30 establish a pneumatic connection to the pneumatic drilled holes 25. During the coupling process between the tractor 12 and the trailer 13, the guide pins 31 already engage in the blind drilled holes 26 of the plug socket 9 and thereby support the further coupling process.

The line pins 32 each have at least one contact element. Each contact element is connected to a line that is connected, for example, to the control unit 18 of the trailer. In the operating state, the line pins 32 are arranged in the line drilled holes 27 of the plug socket 9 and the contact elements in the line drilled holes 27 are in conductive contact with the contact elements of the line pins 32. This enables a line between the towing vehicle 12 and the trailer 13.

The blind drilled holes 26 and the guide pins 31 have several transmitters and receivers (not shown here) of a communication system having a short range. The transmitters and receivers are arranged within the respective material and not on the surface, which is why they are not visible in FIGS. 5 and 6. If the plug 3 and plug socket 9 are in the operating state with their front surfaces 24 and 29 against each other, a sufficiently small distance is established between the transmitters and receivers and data transmission between them is possible. The risk of disrupting data transmission is low. The transmitters and receivers are protected from dirt and mechanical influences. If the range of the transmitters and receivers is chosen so that it is smaller than the distance between neighboring transmitters or neighboring receivers in the plug socket 9 or within the plug 3, the transmitters do not influence one another.

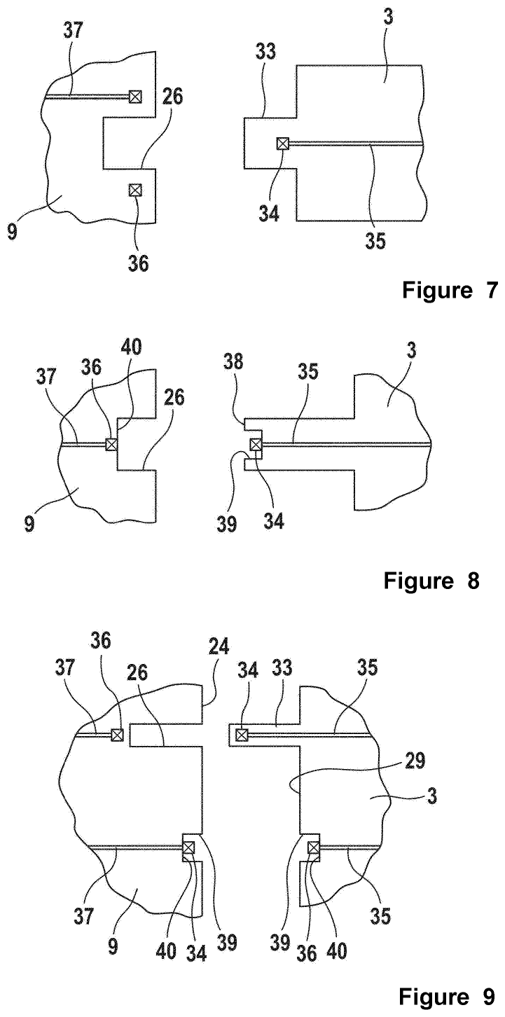

FIGS. 7, 8 and 9 show various embodiments of a plug-in coupling system in schematic form and only in part. A plug 3 and a plug socket 9 are shown in each case.

In FIG. 7, the plug 3 has a blind pin 33 that protrudes perpendicularly from a front surface 29 of the plug 3. A transmitter 34 for a communication system having a short range is arranged in the blind pin 33. The transmitter 34 is connected to a line 35 and is otherwise completely surrounded by the material of the plug 3. The blind pin 33 has no function other than receiving the transmitter 34.

The socket 9 has a pin receptacle in the form of blind drilled holes 26 for the blind pin 33. An annular receiver 36 of the communication system is arranged around the blind drilled holes 27. The receiver 36 is connected to a line 37 and is otherwise completely surrounded by the material of the plug socket 9. The transmitter 34 and receiver 36 are designed to transmit data to each other.

Both the transmitter 34 and the receiver 36 are protected from environmental influences by the material of the plug 3 and the plug socket 9, ensuring permanent, interference-free data transmission between the transmitter 34 and the receiver 36.

In the embodiment according to FIG. 8, the plug 3 again has a blind pin 33. Here, the blind pin 33 has on an end surface 38 a pocket-like receptacle 39 in which a transmitter 34 is arranged. The transmitter 34 is connected with a line 35. In this embodiment, the transmitter 34 is not completely enclosed by the material of the plug 3, but is accessible from the outside.

The corresponding plug socket 9 has a blind drilled hole 26 for the blind pin 33. A receiver 36, which is connected to a line 37, is arranged at the base 40 of the blind drilled hole 26. The receiver 36, like the transmitter 34, is accessible from the outside. In this embodiment, there is no material of the plug 3 or the socket 9 between the transmitter 34 and the receiver 36, leading to better transmission quality.

In the embodiment according to FIG. 9, both the plug 3 and the plug socket 9 have a transmitter 34 and a receiver 36.

The plug 3 again has a blind pin 33, as well as a receptacle 39 on its front surface 29. The transmitter 34 is arranged in the blind pin 33, and the receiver 36 is arranged on the base 40 of the receptacle 39. The transmitter 34 and receiver 36 are each connected with a line 35.

The plug socket 9 has a blind drilled hole 26 for the blind pin 33. In the plug-in direction behind the blind drilled hole 26, the receiver 36 is arranged, which interacts with the transmitter 34 of the plug 3 to enable data transmission. In addition, a receptacle 39 with a base 40 is arranged in the front surface 24 of the plug socket 9. The transmitter 34, which enables data to be transmitted to the receiver 36 of the plug 3, is arranged on the base 40. The transmitter 34 and the receiver 36 of the plug socket 9 are each connected to a line 35.

The four examples show only some of many possible arrangements for the transmitter or transmitters and the receiver or receivers within the plug and plug socket of the coupling system according to the invention.

### LIST OF REFERENCE SYMBOLS

1 Fifth wheel coupling

2 Kingpin

3 Plug

4 Connector

5 Fifth wheel coupling plate

6 Direction of travel of the tractor

7 Entry opening

8 Line

9 Socket

10 Control unit

11 Tractor-trailer

12 Tractor

13 Trailer

14 Coupling system

15 Coupling unit on the tractor

16 Coupling unit on the trailer

17 Plug-in coupling system

18 Control unit

19 Line

20 Carrier unit

21 Base

22 Carrier

23 Socket body

24 Front surface

25 Pneumatic drilled hole

26 Blind drilled hole

27 Line drilled hole

28 Plug body

29 Front surface

30 Pneumatic pin

31 Guide pin

32 Line pin

33 Blind pin

34 Transmitter

35 Line

36 Receiver

37 Line

38 End surface

39 Receptacle

40 Base

What is claimed is:

1. A plug-in coupling system for connecting a towing vehicle and a towed vehicle, optionally comprising a plug device with a plug for the towing vehicle and a plug socket into which the plug can be inserted in an operating state, for the towed vehicle or vice versa, wherein the plug and the socket have at least one transmitter and at least one receiver of a contactless communication system with a short range, wherein the towed vehicle's communication system is connected or connectable with one or more of the following components: the chassis, particularly the braking device, wheels, axles, and steering; and associated sensors, particularly pressure sensors, RPM sensors, temperature sensors and maintenance sensors for wear parts of the chassis; the suspension, particularly associated pressure sensors or position sensors; the sensors, particularly load sensors, stability sensors, further maintenance sensors for wear parts, angle sensors for determining the angle between the towing and towed vehicles and visual sensors; lighting and/or a control device or a distribution unit of the towed vehicle, wherein the control device and/or the distribution unit is in turn connected or connectable to one or more of the aforementioned components.

2. The plug-in coupling system according to claim 1, wherein the plug and/or the plug socket have at least one electrical and/or one pneumatic means of connection.

3. The plug-in coupling system according to claim 1, wherein the plug and the socket are designed such that they can be connected along a straight plug axis.

4. The plug-in coupling system according to claim 3, wherein pins and complementary drilled holes are used as electrical and/or pneumatic means of connection, which extend along the plug axis.

5. The plug-in coupling system according to claim 1, wherein the communication system uses one of the following technologies:
Radio Frequency Identification (RFID)
Near Field Communication (NFC)
Bluetooth Low Energy (BLE)
optical signal transmission
radio technology.

6. The plug-in coupling system according to claim 1, wherein the at least one transmitter and/or the at least one receiver is arranged on and/or in at least one pin, particularly a guide pin and/or a blind pin, and/or a plug body of the plug.

7. The plug-in coupling system according to claim 1, wherein the at least one transmitter and/or the at least one receiver is arranged on and/or in at least one pin receptacle, particularly a blind drilled hole, and/or one socket body of the plug socket.

8. The plug-in coupling system according to claim 7, wherein there is a gap between the blind pin and the blind drilled hole in the operating state.

9. The plug-in coupling system according to claim 7, wherein the plug body and/or the socket body has a receptacle for the transmitter or the receiver.

10. The plug-in coupling system according to claim 1, wherein the plug and/or the plug socket are at least partially made of plastic.

11. A coupling system for connecting a towing vehicle and a towed vehicle, comprising:
a coupling unit for the towing vehicle and a coupling unit for the towed vehicle, wherein the coupling unit for the towed vehicle comprises at least one first mechanical coupling device and the coupling unit for the towing vehicle comprises at least one second mechanical coupling device which interacts with the first mechanical coupling device in an operating state, and the coupling unit for the towed vehicle optionally comprises at least one plug-in device having a plug and the coupling unit for the towing vehicle comprises at least one socket that is arranged on the second mechanical coupling device and complements the plug, and into which the plug can be inserted in the operating state, or vice versa, wherein the plug and the socket have at least one transmitter and at least one receiver of a contactless communication system with a short range, wherein the towed vehicle's communication system is connected or connectable with one or more of the following components: the chassis, particularly the braking device, wheels, axles, and steering; and associated sensors, particularly pressure sensors, RPM sensors, temperature sensors and maintenance sensors for wear parts of the chassis; the suspension, particularly associated pressure sensors or position sensors; the sensors, particularly load sensors, stability sensors, further maintenance sensors for wear parts, angle sensors for determining the angle between the towing and towed vehicles and visual sensors; lighting and/or a control device or a distribution unit of the towed vehicle, wherein the control device and/or the distribution unit is in turn connected or connectable to one or more of the aforementioned components.

12. The coupling system according to claim 11, wherein the towing vehicle is a tractor and the towed vehicle a trailer of a tractor-trailer or the towing vehicle is a motor vehicle and the towed vehicle a trailer of an articulated train or the towing vehicle is a swap body truck and the towed vehicle is a swap body.

13. The coupling system according to claim 11, wherein the towing vehicle is a tractor and the towed vehicle a trailer of a tractor-trailer, wherein the coupling unit for the towed vehicle has at least one kingpin as the first mechanical coupling device and the plug-in device is swivel-mounted around the kingpin and wherein the coupling unit for the towing vehicle has as a second mechanical coupling device at least one fifth wheel which interacts with the kingpin in an operating state.

14. The coupling system according to claim 13, wherein the plug socket on the fifth wheel coupling is immovably fixed below an entry opening.

15. The coupling system according to claim 12, wherein at least one control device arranged on the tractor and/or the trailer which is connected to a sensor for detecting the locking state of at least one of the mechanical coupling devices.

16. The coupling unit for a towing vehicle for a coupling system according to claim 11, further including a second mechanical coupling device and a plug socket arranged on the second mechanical coupling device, wherein the plug socket has at least one transmitter and/or at least one receiver of a contactless communication system having a short range.

17. The coupling unit for a towed vehicle for a coupling system according to claim 11, with the first mechanical coupling device and the plug device which is arranged on the first mechanical coupling device and has a plug, wherein the plug has at least one transmitter and/or at least one receiver of a contactless communication system having a short range, wherein the communication system is connected or connectable to one or more of the following components of the towed vehicle: the chassis, particularly the braking device, wheels, axles, and steering; and associated sensors, particularly pressure sensors, RPM sensors, temperature sensors and maintenance sensors for wear parts of the chassis; the suspension, particularly associated pressure sensors or position sensors; the sensors, particularly load sensors, stability sensors, further maintenance sensors for wear parts, angle sensors for determining the angle between the towing and towed vehicles and visual sensors; lighting and/or a control device or a distribution unit of the towed vehicle, wherein the control device and/or the distribution unit is in turn connected or connectable to one or more of the aforementioned components.

18. The coupling unit for a towing vehicle for a coupling system according to claim 13, with the fifth wheel and a plug socket arranged on the fifth wheel, wherein characterized in that the plug socket has at least one transmitter and/or at least one receiver of a contactless communication system with a short range.

19. The coupling unit for a towed vehicle for a coupling system according to claim 13, with the kingpin and the plug-in device which is pivotably mounted about the kingpin and has the plug, wherein the plug has at least one transmitter and/or at least one receiver of a contactless communication system having a short range, the communication system being connected or connectable to one or more of the following components on the part of the towed vehicle: the chassis, particularly the braking device, wheels, axles, and steering; and associated sensors, particularly pressure sensors, RPM sensors, temperature sensors and maintenance sensors for wear parts of the chassis; the suspension, particularly associated pressure sensors or position sensors; the sensors, particularly load sensors, stability sensors, further maintenance sensors for wear parts, angle sensors for determining the angle between the towing and towed vehicles and visual sensors; lighting and/or a control device or a distribution unit of the towed vehicle, wherein the control device and/or the distribution unit is in turn connected or connectable to one or more of the aforementioned components.
